(19) United States
(12) Patent Application Publication
(10) Pub. No.: US 2013/0100396 A1
(43) Pub. Date: Apr. 25, 2013

(54) EYEGLASS FRAME HAVING ROTATABLE TEMPLE INSERTS

(71) Applicants: Steven B. Liebers, Collegeville, PA (US); Zhongqiu Zhu, Wenzhou (CN)

(72) Inventors: Steven B. Liebers, Collegeville, PA (US); Zhongqiu Zhu, Wenzhou (CN)

(73) Assignee: DIVERSIFIED PRODUCTS, INC., Collegeville, PA (US)

(21) Appl. No.: 13/489,912

(22) Filed: Jun. 6, 2012

Related U.S. Application Data
(63) Continuation-in-part of application No. 13/573,414, filed on Oct. 24, 2011.

(51) Int. Cl. G02C 11/02

(52) U.S. Cl. 351/52

(57) ABSTRACT

An eyeglass frame having a pair of temple arms and a lens frame is provided, each temple arm having a first end rotatably disposed on the lens frame, a second end, and at least one aperture between the first and second end. A flat, ornamental insert having two sides is pivotally disposed in each aperture from a first position to a second position wherein the ornamental insert is secured in the aperture by a pivot pin about which the ornamental insert pivots such that one of the two sides is visible on an outer surface of its associated temple arm. Each ornamental insert has at least one magnet to mate with an magnet attraction surface in its associated temple arm to secure the ornamental insert in position for wear.

### CROSS-REFERENCE TO RELATED APPLICATION

This application is a continuation-in-part of U.S. Utility patent application Ser. No. 29/404,662, filed Oct. 24, 2011, entitled Eyeglass Frame Having Rotatable Temple Inserts, pending.

### BACKGROUND OF THE INVENTION

The present invention is directed to eyeglass frames. More particularly, the present invention is directed to decorative features on the temple arms of eyeglass frames.

Eyeglass frames typically include a pair of temple arms and a lens frame. In the past, numerous designs have been directed to decorative aspects of the the temple arms. For example, U.S. Pat. No. 5,007,728 (Magorien) is directed to an eyeglass frame having removable temple arms where a portion of each temple arm snaps into place with an integral fastener on another portion of the temple arm located adjacent to its lens frame.

U.S. Pat. No. 6,652,093 (Lamy) is directed to an eyeglass frame having a lens frame and a pair of temple arms. The temple arms have three pieces including a first position adjacent to and hinged to the lens frame, an end portion having a curved ear piece, and a third portion rotationally disposed between the first portion and the end portion. Hinge points allow the middle portion to rotate about the longitudinal axis of each temple arm.

U.S. Pat. No. 6,834,952 (Polovin) is directed to an eyeglass frame having detachable and replaceable temple arms wherein each temple arm attaches using an integral fastener.

U.S. Pat. No. 7,261,409 (Taber) is directed to an eyeglass frame having an integral channel to receive separate decorative inserts.

U.S. Pat. No. 7,645,039 (Sheldon) is directed to an eyeglass frame having two interchangeable temple sections.

All references cited herein are incorporated herein by reference in their entireties.

### BRIEF SUMMARY OF THE INVENTION

An eyeglass frame having a pair of temple arms and a lens frame is provided. The eyeglass frame may be, for example, for reading glasses, sunglasses or any other type of optical frames. Each temple arm is rotatably disposed on the lens frame. Each temple arm includes a first end rotatably disposed on the lens frame, a second end, and at least one aperture between the first and second end. A flat, ornamental insert having two sides is pivotally disposed in each aperture from a first position to a second position. Each ornamental insert is secured in its aperture by a pivot pin about which the ornamental insert pivots such that one of the two sides is visible on an outer surface of its associated temple arm.

Ornamentation on one of the sides of the ornamental inserts may be substantially identical to ornamentation on its associated temple arms to blend in with said temple arm. Ornamentation on at least one of said sides of the ornamental insert may contrast with color or pattern of that of its associated temple arm. Each pivot pin is disposed substantially perpendicular to a longitudinal axis of its associated temple arm. Each ornamental insert may have at least one protuberance adapted to mate with an associated aperture in its associated temple arm to secure the ornamental insert in position for wear.

In a more detailed embodiment of the present invention, an eyeglasses frame having a pair of temple arms and a lens frame is provided. Each temple arm includes a first end rotatably disposed on the lens frame, a second end, and at least one aperture between the first and second end. A flat, ornamental insert having two sides, is pivotally disposed in each aperture from a first position to a second position. The ornamental insert is secured in the aperture by a pivot pin about which the ornamental insert pivots within the aperture such that one of the two sides is visible on an outer surface of its associated temple arms. Ornamentation on at least one of said sides of the ornamental insert contrasts with color or pattern that of its associated temple arm. Each pivot pin is disposed substantially perpendicular to a longitudinal axis of its associated temple arm. Each ornamental insert has at least one magnet adapted to mate with a magnet attraction surface in its associated temple arm to secure the ornamental insert in position for wear. Alternatively, the ornamental insert may include the magnet attraction surface, while the temple arm may include the magnet.

### BRIEF DESCRIPTION OF SEVERAL VIEWS OF THE DRAWINGS

The invention will be described in conjunction with the following drawings in which like reference numerals designate like elements and wherein:

FIG. 1 is a front isometric view of an eyeglass frame in accordance with a exemplary embodiment of the present invention, shown with ornamental inserts in position for wear;

FIG. 2 is a rear isometric view of the eyeglass frame of FIG. 1;

FIG. 3 is a side isometric view of the eyeglass frame of FIG. 1;

FIG. 3A is a cross sectional view of the eyeglass frame of FIG. 1, taken substantially along lines 3A-3A of FIG. 3;

FIG. 4 is a front isometric view of the eyeglass frame of FIG. 1, shown with ornamental inserts in a partially rotated position;

FIG. 5 is a rear isometric view of the eyeglass frame of FIG. 1, shown with ornamental inserts in a partially rotated position;

FIG. 6 is a side isometric view of the eyeglass frame of FIG. 1, shown with ornamental inserts in a partially rotated position;

FIG. 6A is a detail view of a temple arm of the eyeglass frame of FIG. 1, taken at view “FIG. 6A” of FIG. 6;

FIG. 7 is a side isometric view of an eyeglass frame in accordance with a second exemplary embodiment of the present invention, shown with ornamental inserts in position for wear;

FIG. 7A is a cross sectional view of the eyeglass frame of FIG. 7, taken substantially along lines 7A-7A of FIG. 7;

FIG. 8 is a front isometric view of the eyeglass frame of FIG. 7, shown with ornamental inserts in a partially rotated position;

FIG. 9 is a rear isometric view of the eyeglass frame of FIG. 7, shown with ornamental inserts in a partially rotated position;

FIG. 10 is a side isometric view of the eyeglass frame of FIG. 7, shown with ornamental inserts in a partially rotated position; and

FIG. 10A is a detail view of a temple arm of the eyeglass frame of FIG. 7, taken at view “FIG. 10A” of FIG. 10.

### DETAILED DESCRIPTION OF THE INVENTION

The invention will be illustrated in more detail with reference to the following embodiments, but it should be understood that the present invention is not deemed to be limited thereto.

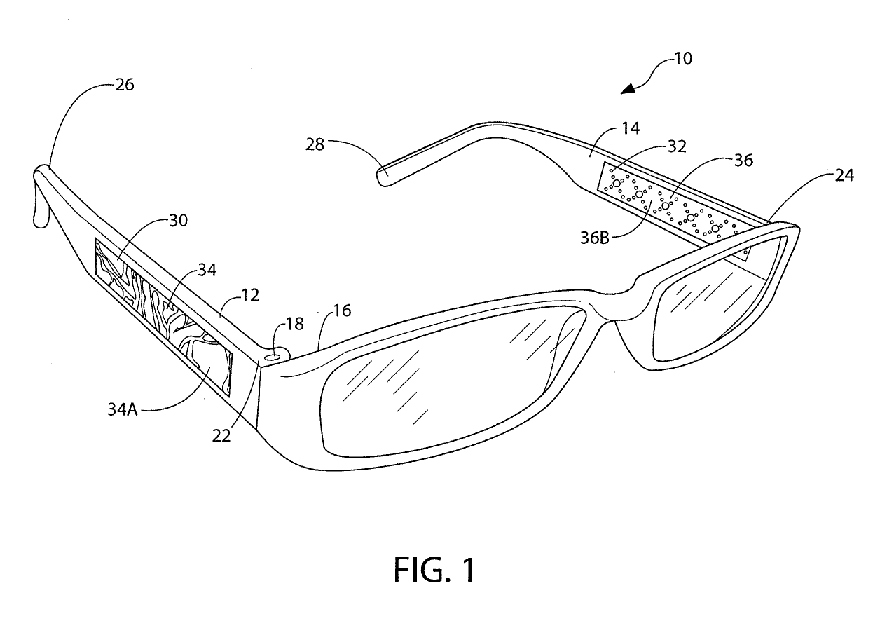

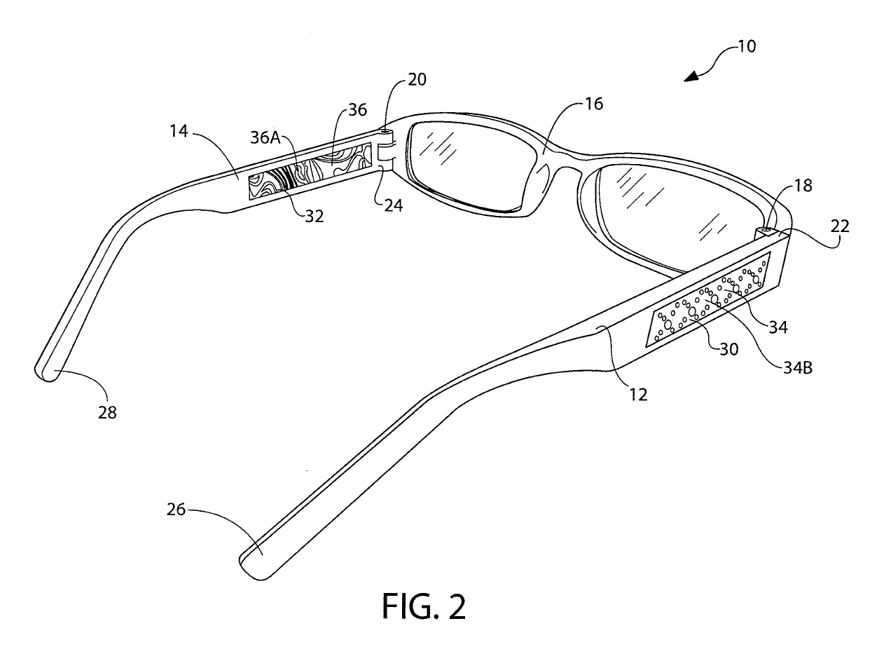

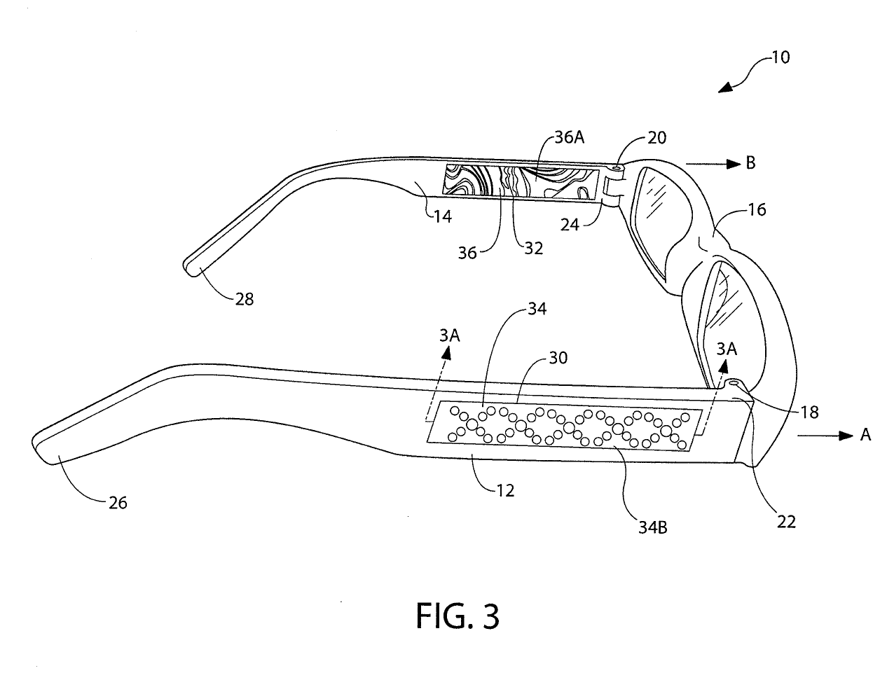

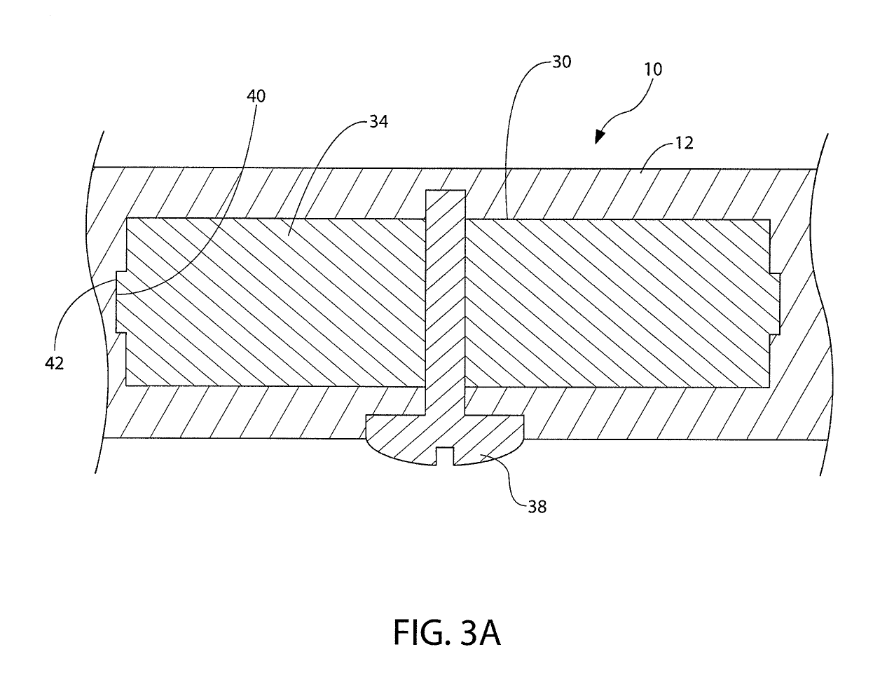

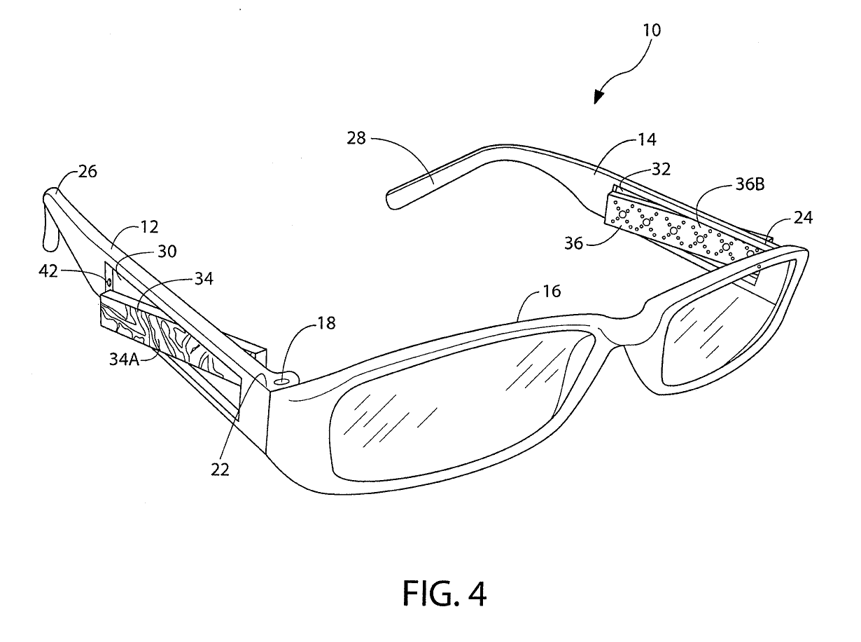

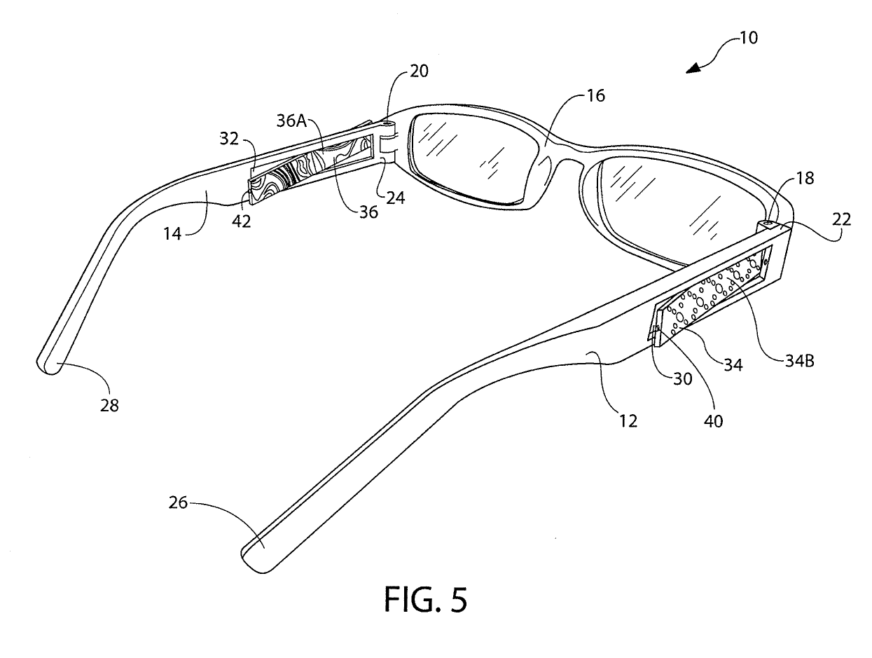

Referring now to the drawing figures, wherein like part numbers refer to like elements throughout the several views, there is shown in FIGS. 1-3 and 4-6 an eyeglass frame 10 in accordance with a preferred embodiment of the present invention. The eyeglass frame 10 has a pair of temple arms 12, 14 and a lens frame 16. Each temple arm 12, 14 is rotatably disposed on the lens frame using a hinge 18, 20. Each temple arm 12, 14 includes a first end 22, 24 rotatably disposed on the lens frame 16, a second end 26, 28, and at least one aperture 30, 32 between the first end 22, 24 and second end 26, 28 associated with that temple arm 12, 14. A flat, ornamental insert 34, 36 having two sides 34A, 34B, 36A, 36B is pivotally disposed in each aperture 30, 32 from a first position to a second position (compare FIG. 1 to FIG. 2). The ornamental insert 34, 36 is secured in its associated aperture 30, 32 by a pivot pin 38 (see FIG. 3A) about which the ornamental insert 34, 36 pivots within the aperture 30, 32 such that one of the two sides 34A or 34B, 36A or 36B is visible on an outer surface of its associated temple arm.

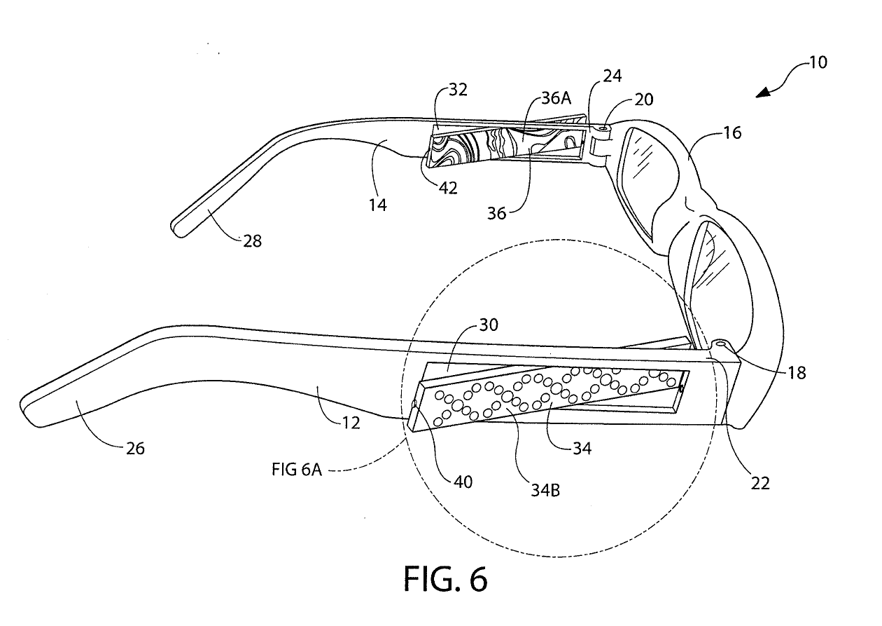

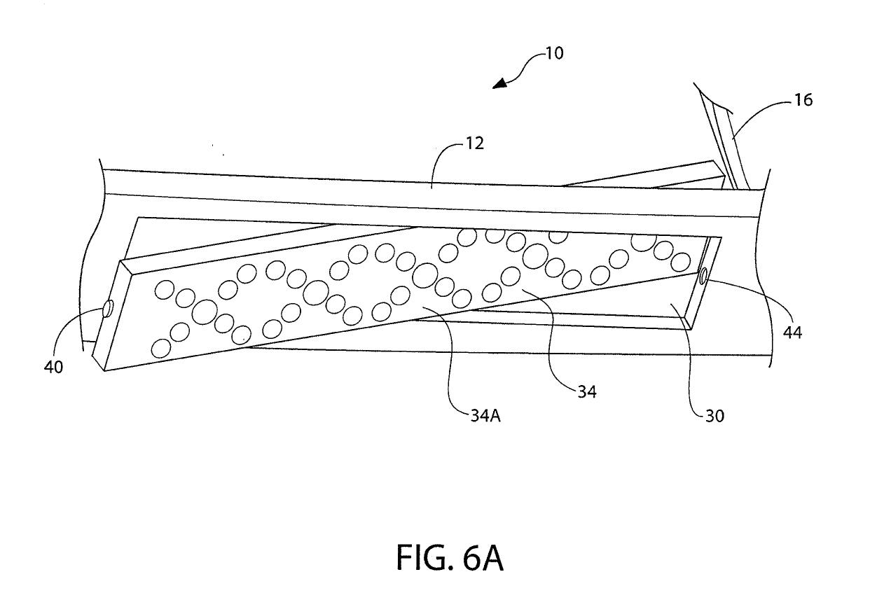

Ornamentation on one of said sides 34A, 34B, 36A, 36B of the ornamental inserts 34, 36 may be substantially identical to ornamentation on its associated temple arms 12, 14 to blend in with the temple arm 12, 14. Alternatively, ornamentation on at least one of said sides 34A, 34B, 36A, 36B of the ornamental insert 34 may contrast with color or pattern of its associated temple arm 12, 14, as shown in the various figures. Each pivot pin 38 may be disposed substantially perpendicular to a longitudinal axis A, B (see FIG. 3) of its associated temple arm 12, 14. Each ornamental insert 34, 36 has at least one protuberance 40, 42 adapted to mate with an associated aperture 44, for example, by an interference fit, in its associated temple arm 12, 14 to secure the ornamental insert 34, 36 in position for wear, i.e., to prevent the ornamental insert 34, 36 from rotating. The protuberance 40, 42 and or aperture 44 may be on one or both ends of each ornamental inserts 34, 36. See FIG. 6A.

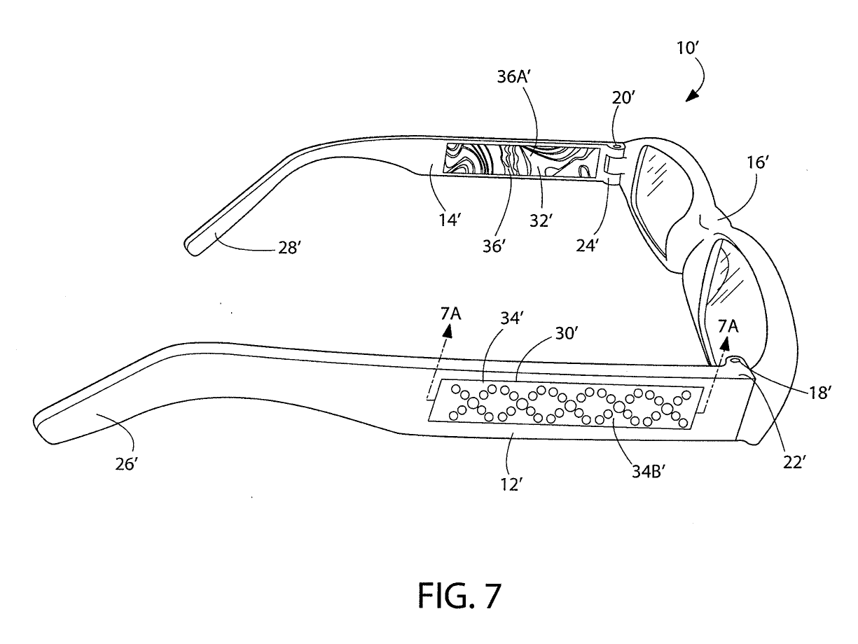

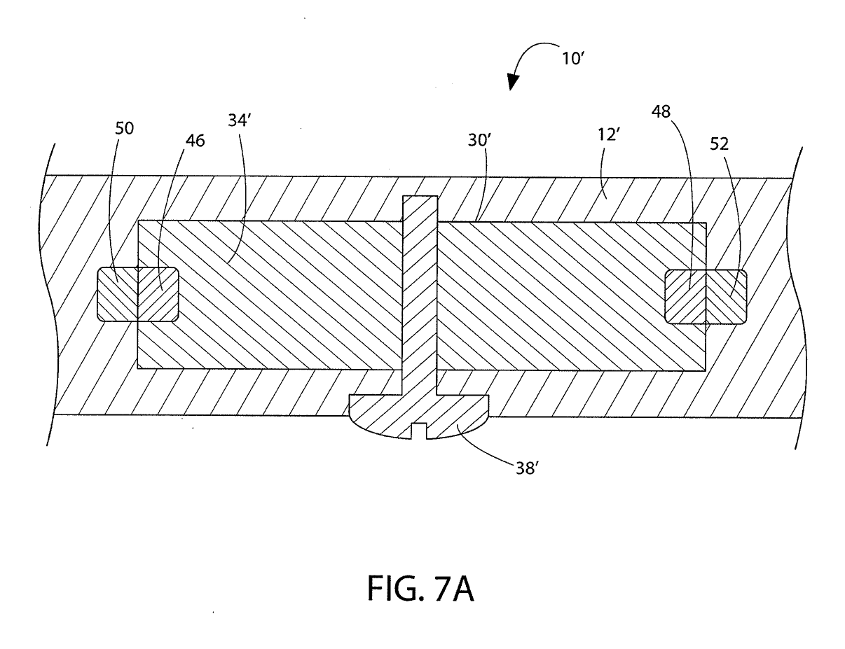

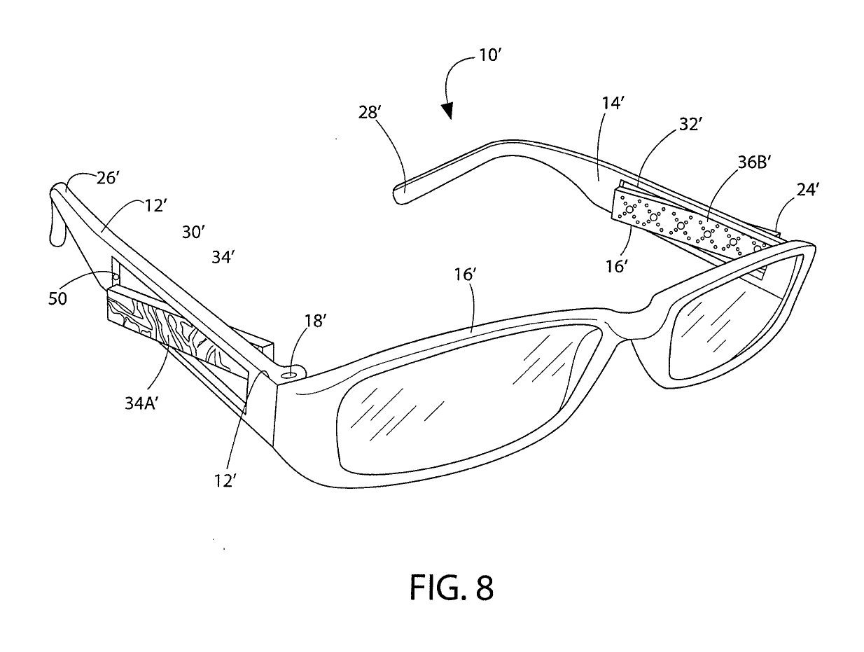

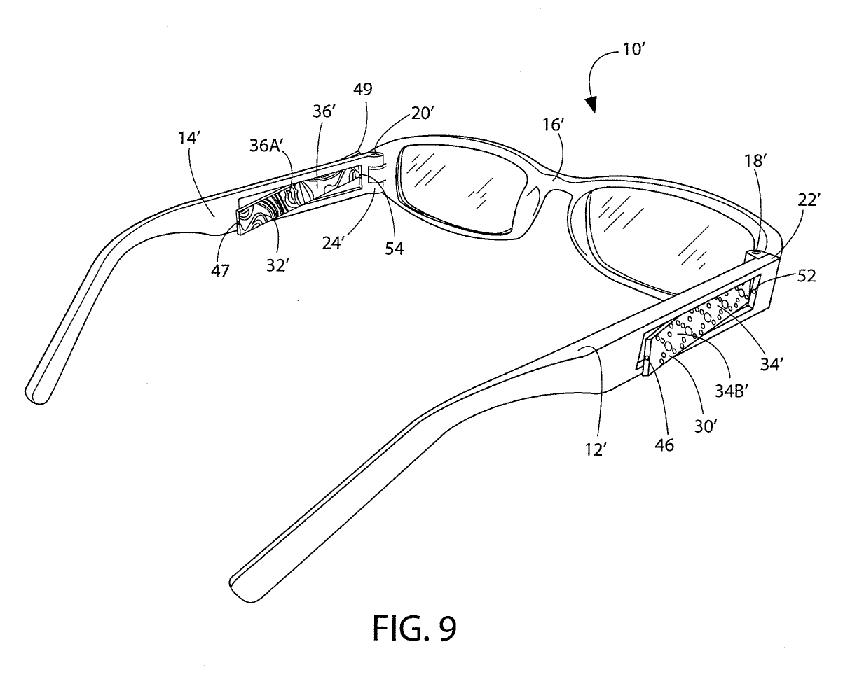

Referring now to drawing FIGS. 7, 7A, 8-10 and 10A, there is shown an eyeglass frame 10′ in accordance with a second exemplary embodiment of the present invention. For the sake of convenience, the numbering of claim elements of the embodiment of FIGS. 7, 7A, 8-10 and 10A will follow that of the first embodiment, described above, except that a prime symbol will be placed after the reference number. No further description is deemed necessary here. For example, the eyeglass frame 10 of the first embodiment is designated eyeglass frame 10′ in the second embodiment. Similarly, the pair of temple arms 12, 14 of the first embodiment are designated 12′, 14′ in the second embodiment.

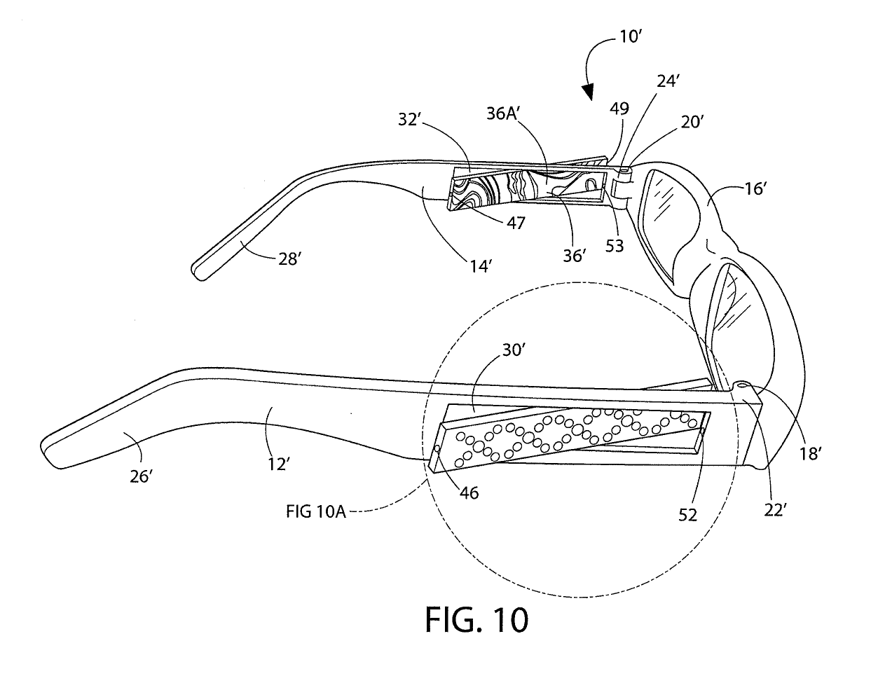

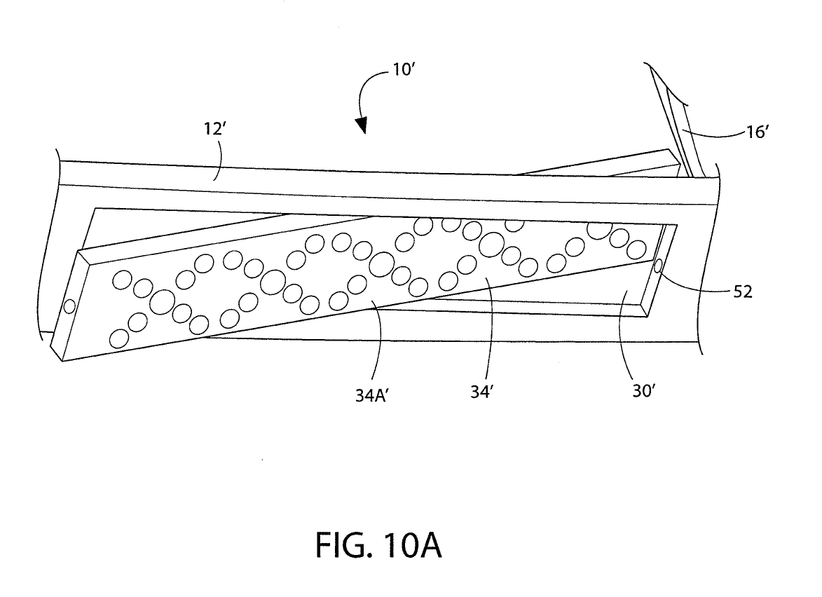

Generally, eyeglass frame 10′ is identical to that of the eyeglass frame 10 except, rather than each ornamental insert 34, 36 having at least one protuberance 40, 42 adapted to mate with an associated aperture 44 by an interference fit, in its associated temple arm 12, 14 to secure the ornamental insert 34, 36 in position for wear, i.e., to prevent the ornamental insert 34, 36 from rotating, magnets 46, 48 are embedded in the ornamental insert 34′, 36′. See FIG. 7A, in particular. The magnets 46, 48, 48, 49 may be on one or both ends of each ornamental inserts 34′, 36′. See FIG. 10A. The magnets 46, 48 are attracted to a magnet attraction surface 50, 51, 52, 53 (such as another magnet) on the adjacent temple arm 12′ 14′. Obviously, the magnets 46, 47, 48, 49 and the magnet attraction surfaces 50, 51, 52, 53 may be reversed such that the magnets 46, 48 may be in the frame temple arms 12′, 14′ and the magnet attraction surfaces 50, 52 may be on the ornamental inserts 34′, 36′.

While the invention has been described in detail and with reference to specific embodiments, it will be apparent to one skilled in the art that various changes and modifications can be made therein without departing from the spirit and scope thereof.

What is claimed is:

1. An eyeglass frame having a pair of temple arms and a lens frame, each temple arm comprising:
(a) a first end rotatably disposed on the lens frame, a second end, and at least one aperture between the first and second end; and
(b) a flat, ornamental insert having two sides, pivotally disposed in each said aperture from a first position to a second position, said ornamental insert secured in said aperture by a pivot pin about which the ornamental insert pivots within said aperture such that one of said two sides is visible on an outer surface of its associated temple arm; and
(c) wherein each ornamental insert has at least one magnet adapted to mate with an magnet attraction surface in its associated temple arm to secure the ornamental insert in position for wear.

2. The eyeglass frame of claim 1, wherein ornamentation on one of said sides of the ornamental inserts is substantially identical to ornamentation on its associated temple arms to blend in with said temple arm.

3. The eyeglass frame of claim 1, wherein ornamentation on at least one of said sides of the ornamental insert contrasts with color or pattern of its associated temple arm.

4. The eyeglass frame of claim 1, wherein each pivot pin is disposed substantially perpendicular to a longitudinal axis of its associated temple arm.

5. The eyeglass frame of claim 1, wherein each ornamental insert has at least one protuberance adapted to mate with an associated aperture in its associated temple arm to secure the ornamental insert in position for wear.

6. An eyeglass frame having a pair of temple arms and a lens frame, each temple arm comprising:
(a) a first end rotatably disposed on the lens frame, a second end, and at least one aperture between the first and second end; and
(b) a flat, ornamental insert having two sides, pivotally disposed in each said aperture from a first position to a second position, said ornamental insert secured in said aperture by a pivot pin about which the ornamental insert pivots within said aperture such that one of said two sides is visible on an outer surface of its associated temple arm; and
(c) wherein each temple arm has at least one magnet adapted to mate with an magnet attraction surface in its associated ornamental insert to secure the ornamental insert in position for wear.

7. The eyeglass frame of claim 6, wherein ornamentation on one of said sides of the ornamental inserts is substantially identical to ornamentation on its associated temple arms to blend in with said temple arm.

8. The eyeglass frame of claim 6, wherein ornamentation on at least one of said sides of the ornamental insert contrasts with color or pattern of its associated temple arm.

9. The eyeglass frame of claim 6, wherein each pivot pin is disposed substantially perpendicular to a longitudinal axis of its associated temple arm.

10. The eyeglass frame of claim 6, wherein each ornamental insert has at least one protuberance adapted to mate with an associated aperture in its associated temple arm to secure the ornamental insert in position for wear.
